(19) United States
(12) Patent Application Publication
(10) Pub. No.: US 2026/0308000 A1
(43) Pub. Date: Oct. 8, 2026

(54) SYSTEMS AND METHODS FOR THE PRODUCTION OF AMMONIA

(71) Applicant: The Mosaic Company, Tampa, FL (US)

(72) Inventors: Muhamad F. FOUAD, Gonzales, LA (US); Matthew J. DUHE, Paulina, LA (US); Joshua S. BALDASSARO, Gonzales, LA (US); Joel R. VOGEL, Lakeland, FL (US)

(21) Appl. No.: 19/485,179

(22) PCT Filed: May 15, 2024
(86) PCT No.: PCT/US2024/029482

§ 371 Date: Nov. 17, 2025

Related U.S. Application Data
(60) Provisional application No. 63/502,271, filed on May 15, 2023.

(51) Int. Cl. C01C 1/04

(52) U.S. Cl. CPC C01C 1/0417; C01C 1/0452

(57) ABSTRACT

Systems and methods for ammonia synthesis integrating an ammonia absorption refrigeration cycle and an ammonia synthesis cycle. The ammonia synthesis cycle includes a multistage non-adiabatic reactor system formed of multiple non-adiabatic reactors for converting a synthesis gas containing hydrogen and nitrogen into ammonia. The ammonia is chilled and stored as a cold ammonia product. Lean solution from the ammonia absorption refrigeration cycle can be used as a heat exchange utility fluid for the reactors, and the refrigeration cycle can also be used to chill the ammonia from the synthesis cycle for cold storage. Almost all of the syngas is converted in a single pass through the multistage non-adiabatic reactor system, eliminating the need for recycle streams and associated energy consumption.

### CROSS REFERENCE TO RELATED APPLICATIONS

This application claims the benefit of U.S. Provisional Application Ser. No. 63/502,271, filed May 15, 2023, which is incorporated by reference in its entirety.

### FIELD OF INVENTION

The present disclosure relates generally to ammonia synthesis, and more particularly to methods and systems for efficiently producing ammonia.

### BACKGROUND

Ammonia production (NH₃) accounts for approximately 80% of the fertilizer industry's total energy consumption globally. Producing ammonia requires a multistep, energy intensive process, known as the Haber-Bosch process. The Haber-Bosch process converts atmospheric nitrogen (N₂) to ammonia (NH₃) by a reaction with hydrogen (H₂) using an iron metal catalyst under high temperatures and pressures. Ammonia synthesis reaction can generally be written as follows:

$${N}_{2} ( g ) + 3 {H}_{2} ( g ) = 2 {NH}_{3} ( g ) , {Δ H}_{r} = - 92 kJ / mol \qquad ( Formula 1 )$$

This reaction is slightly exothermic (i.e. it releases energy), meaning that the reaction is favored at lower temperatures and higher pressures, and is reversible. It decreases entropy, complicating the process because it produces fewer molecules than with which it started. Although the Haber-Bosch process has undergone various degrees of optimization, ammonia production still remains limited by thermodynamics to typically less than 20% conversion in a single pass.

Generally, the process requires that hydrogen is produced via steam reforming, followed by an iterative closed cycle to react hydrogen with nitrogen to produce ammonia. More particularly, steam reforming of light hydrocarbons, such as natural gas, is the most used method for the large-scale ammonia production, where natural gas is purified, then converted to hydrogen via steam reforming or partial oxidation of the natural gas, thereby forming of synthesis gas, or syngas. The syngas in turn is utilized in the synthesis of ammonia in the presence of nitrogen per the above reaction. The total energy consumption of the production of ammonia in these large-scale steam reformers is approximately 50% greater than the theoretical thermodynamic minimum. This elevated energy consumption is largely contributed to compression losses throughout these steam reforming processes.

Once the ammonia is produced, it is separated from unreacted N₂ and H₂, which must then be repressurized, reheated, and recycled. The process utilizes vapor compression cycles during ammonia synthesis to compress unreacted nitrogen and hydrogen into recycle streams directed back into the ammonia synthesis process. Because the nitrogen conversion rates of these processes are typically less than 20%, the recycle streams are large and therefore require large amounts of compression work before the unreacted nitrogen and hydrogen can be directed back into the synthesis process. All of this in addition to the steam reforming step contributes to high energy consumption and greenhouse gas emissions.

There is a need in the industry for an improvement to the currently ammonia production process to address this elevated energy consumption and greenhouse gas emissions.

### SUMMARY

The problems described above are largely addressed by the process described herein. A method for ammonia synthesis and system comprises integrating an ammonia absorption refrigeration cycle and an ammonia synthesis cycle, the ammonia synthesis cycle comprising a multistage non-adiabatic reactor system, supplying waste heat from the ammonia synthesis cycle to the ammonia absorption refrigeration cycle, and supplying lean solution from the ammonia absorption refrigeration cycle to the ammonia synthesis cycle as a heat exchange utility fluid.

In embodiments, a system for producing ammonia includes an ammonia absorption refrigeration cycle, wherein a refrigerant comprises ammonia, and an ammonia synthesis cycle comprising a multistage, non-adiabatic reactor system. The multistage, non-adiabatic reactor system is a series of reactors, each of which is configured to receive a synthesis gas containing hydrogen and nitrogen to be reacted in the presence of a catalyst to produce a gaseous reaction mixture containing an ammonia. The gaseous reaction mixture is condensed and the ammonia product is separated and further chilled for storage. The unreacted mixture (if present) is converted to syngas and enters the next reactor in the series of reactors of the system until almost all the syngas has been converted in a single pass through the entire system. Waste heat from the ammonia synthesis cycle is supplied to the ammonia absorption refrigeration cycle, and lean ammonia solution from the ammonia absorption refrigeration cycle is supplied to the reactor system as a heat exchange fluid.

In embodiments, the ammonia absorption refrigeration cycle is configured to supply lean ammonia solution to the multi-stage, non-adiabatic reactor system to control a thermal condition of the reactor system. For example, the lean ammonia solution can cool the non-adiabatic reactors to a temperature that favors nitrogen conversion. The lean solution from the ammonia absorption refrigeration cycle is supplied to and then returned from each reactor of the multistage, non-adiabatic reactor system. In one non-limiting example, the multistage, non-adiabatic reactor system comprises at least two ammonia reactors and at least one heat exchanger. The reaction mixture exits the ammonia synthesis cycle and is directed to an ammonia chiller system, wherein the ammonia is chilled and pumped to storage. In embodiments, a nitrogen conversion of the syngas of the ammonia synthesis cycle is at least 85%, at least 90%, or at least 95%, such that there is no need for a recycled syngas stream.

In embodiments, the ammonia absorption refrigeration cycle includes an evaporator configured to convert liquid ammonia to gaseous ammonia, an absorber configured to combine the gaseous ammonia with water to form an ammonia-rich solution, a generator configured to heat the ammonia-rich solution to convert the ammonia contained therein to gaseous ammonia while the remaining solution (lean ammonia solution) remains liquid to be returned to the absorber, and a condenser for condensing the gaseous ammonia from the generator into liquid ammonia to be returned to the evaporator. The ammonia absorption refrigeration cycle can further include a pump configured to pump the ammonia-rich solution to the generator, a pressure reducing valve positioned between the generator and the absorber and configured to reduce a pressure of the remaining solution returning from the generator to the absorber, and an expansion valve positioned between the condenser and the evaporator and configured to reduce a pressure of the liquid ammonia returning from the condenser to the evaporator. A heat exchanger can also be positioned between the absorber and the generator to heat the ammonia-rich solution and/or cool the lean ammonia solution.

In embodiments, a method of producing ammonia can include introducing a synthesis gas comprising hydrogen and nitrogen to an ammonia synthesis cycle comprising a multistage, non-adiabatic reactor system to produce a reaction mixture containing ammonia product and unreacted synthesis gas, separating the ammonia product from the unreacted synthesis gas (if present), providing the ammonia product to a chiller system, and providing a lean ammonia solution from an ammonia absorption refrigeration cycle to the reactor system as a heat exchange fluid. The method can further include providing waste heat from the ammonia synthesis cycle is supplied to the ammonia absorption refrigeration cycle. In embodiments, the reaction mixture is produced from the synthesis gas in a single pass through the multistage, non-adiabatic reactor system. In embodiments, the chiller system utilizes ammonia refrigerant from the ammonia absorption cycle. In embodiments, a nitrogen conversion of the ammonia synthesis cycle is at least 85%, at least 90%, or at least 95%, such that the ammonia synthesis cycle is completely free of the need for a recycled syngas stream.

In embodiments, the ammonia absorption refrigeration cycle can include providing liquid ammonia to an evaporator, evaporating the liquid ammonia to form a gaseous ammonia stream and a cooling effect, absorbing the gaseous ammonia stream into water in an absorber to form an ammonia rich solution, heating the ammonia rich solution in a generator to vaporize the ammonia in the ammonia rich solution to form a high pressure ammonia gas and the lean ammonia solution, providing the high pressure ammonia gas to a condenser to condense the high pressure ammonia gas into a high pressure ammonia liquid, converting the high pressure ammonia liquid to a low pressure ammonia liquid, and returning the low pressure ammonia liquid to the evaporator. Further, after the ammonia has been vaporized from the ammonia rich solution, the method can include returning the lean ammonia solution to the absorber and/or to the reactor system. The generator, heat exchanger, pump, condenser, and/or evaporator can be powered by the waste heat from the reactions.

The above summary is not intended to describe each illustrated example or every implementation of the subject matter hereof. The figures and the detailed description that follow more particularly exemplify various examples.

### BRIEF DESCRIPTION OF THE DRAWINGS

The invention may be more completely understood in consideration of the following detailed description of embodiments of the invention in connection with the accompanying drawings, in which:

FIG. 1 is a perspective view of an example of related art;

FIG. 2 is a process flow diagram of an example of related art;

FIG. 3 is a process flow diagram of an example of related art;

FIG. 4 is a schematic view of an example of related art;

FIG. 5A is a schematic view of an example of related art;

FIG. 5B is a schematic view of an example of related art;

FIG. 6 is a diagram illustrating the relationship between the conversion of nitrogen in an ammonia synthesis reactor and the temperature of a particular conversion bed, related to an example of related art;

FIG. 7 is a table related to an example of related art;

FIG. 8 is a schematic view of a method of ammonia synthesis;

FIG. 9A is a schematic view of a method of ammonia synthesis;

FIG. 9B is a perspective view of a system that executes a method of ammonia synthesis;

FIG. 9C is a diagram illustrating the relationship between absorption pressure and a temperature cycle of a method of ammonia synthesis;

FIG. 10 is a schematic view of a system for ammonia synthesis;

FIG. 11 is a schematic of a method of ammonia synthesis.

When embodiments are amenable to various modifications and alternative forms, specifics thereof have been shown by way of example in the drawings and will be described in detail. It should be understood that the intention is not to limit the invention to the particular embodiments described. The intention is to cover all modifications, equivalents, and alternatives falling within the spirit and scope of the invention as defined by the appended claims.

### DETAILED DESCRIPTION

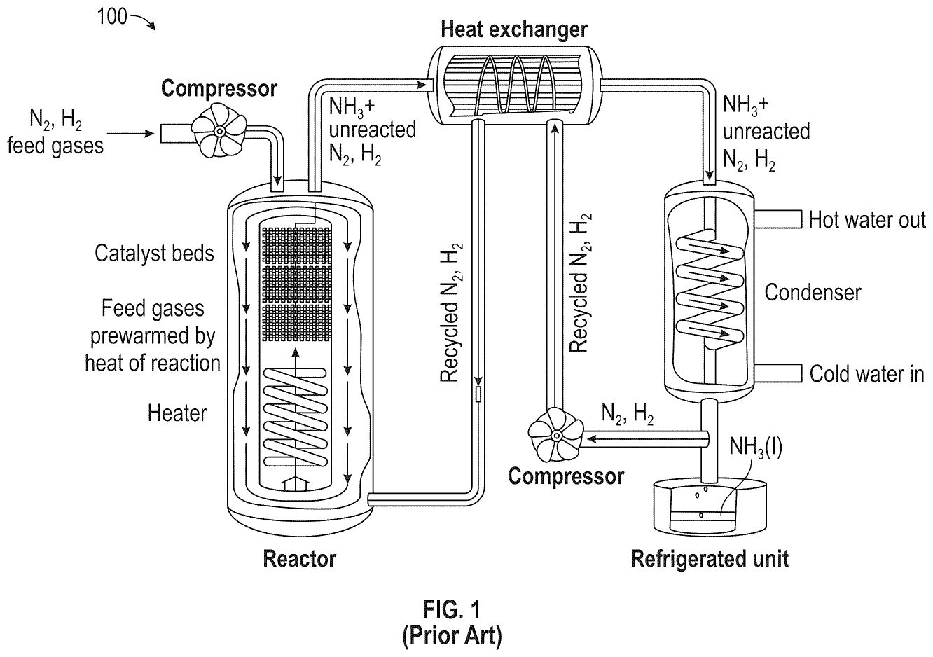

As discussed previously, current methods of ammonia synthesis rely primarily on the Haber-Bosch process, a well-known method known to one of ordinary skill in the art. FIG. 1 depicts an example of related art for a method of ammonia synthesis, relying on the Haber-Bosch process. Synthesis by the Haber-Bosch process requires nitrogen and hydrogen gasses be fed into a compressor before entering a reactor. In the reactor, some of the nitrogen gas and hydrogen gas react to form ammonia. The newly formed ammonia and any unreacted nitrogen and hydrogen are then fed into a heat exchanger. In the heat exchanger, the ammonia and unreacted nitrogen and unreacted hydrogen are cooled, then directed into a condenser. The condenser outputs the newly formed liquid ammonia into a refrigerated unit for storage as a liquid. The cooled unreacted nitrogen and hydrogen gasses exit the condenser and are compressed and directed back to the heat exchanger for warming, before finally being recycled back into the reactor.

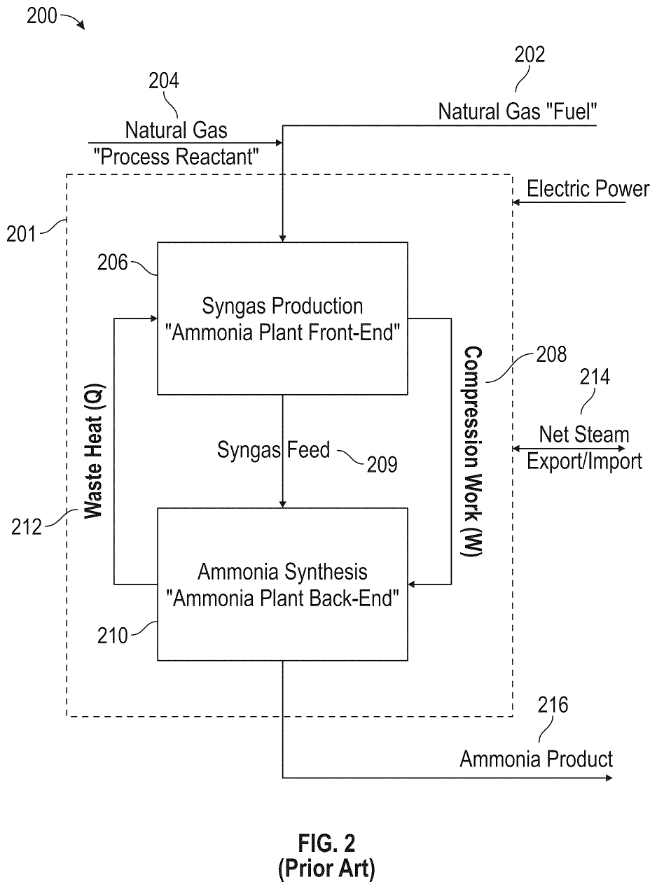

FIG. 2 similarly depicts an example of related art for a system 200 for carrying out a method of ammonia synthesis. Generally, the ammonia plant or system 201 comprises a “front end” which includes a syngas production unit 206 (e.g. steam reforming) for producing hydrogen gas from a natural gas, and a “back end” which includes an ammonia synthesis unit 210 for producing ammonia from hydrogen and nitrogen gasses.

More specifically, natural gas fuel 202 and natural gas process reactant is directed into the syngas production unit 206. The produced syngas feed 209 containing hydrogen undergoes compression 208 before being directed to the ammonia synthesis unit 210. Compression is required to bring the syngas to the favored reaction conditions (pressure and temperature) for producing ammonia, as the synthesis reaction favors higher pressure and lower temperature gasses. Waste heat 212 from the ammonia synthesis unit 210 produced from the exothermic reaction is directed back to the synthesis production unit, used in the steam reforming of the natural gas. Newly formed ammonia product 216 undergoes compression 208 for refrigeration purposes. The newly formed ammonia product 216 exits the ammonia synthesis unit 210 as a liquid. Steam 214 is directed into or out of the ammonia plant 201 as required for equilibrium.

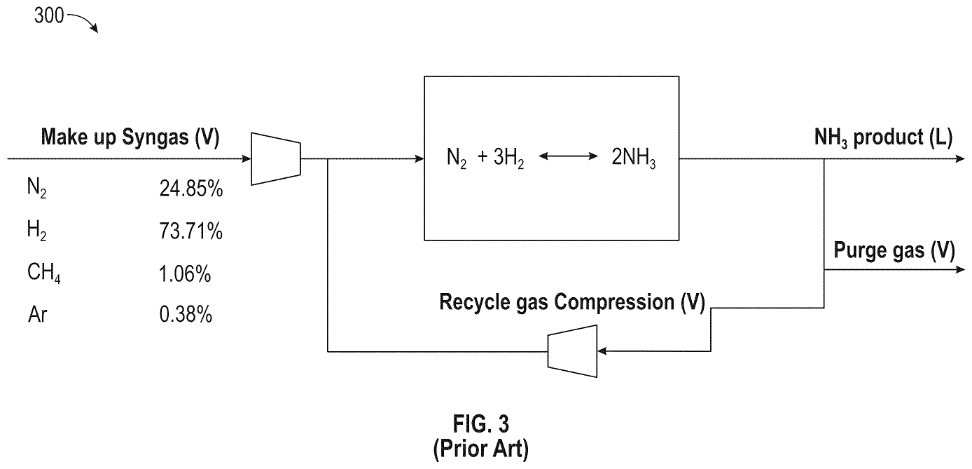

FIG. 3 depicts an example of related art for a method of ammonia synthesis, which requires the compression of syngas prior to the reaction of nitrogen and hydrogen into ammonia, as well as an additional compression stage for any unreacted nitrogen and hydrogen for the unreacted nitrogen and hydrogen to be recycled back into the ammonia synthesis process. Because the synthesis of ammonia is not a complete reaction, the unreacted nitrogen and hydrogen gasses must be compressed back to reaction conditions after being separated from the product ammonia. Further, because of this relatively low single pass conversion rate of syngas to ammonia, the recycle stream must be relatively large. A large recycle stream contributes to overall greater energy consumption by this method of ammonia synthesis because it requires a large recycle stream there will be a greater inert content, a higher synthesis loop pressure, an additional, dedicated compression stage, and more work by the ammonia refrigeration system (depicted in FIG. 2).

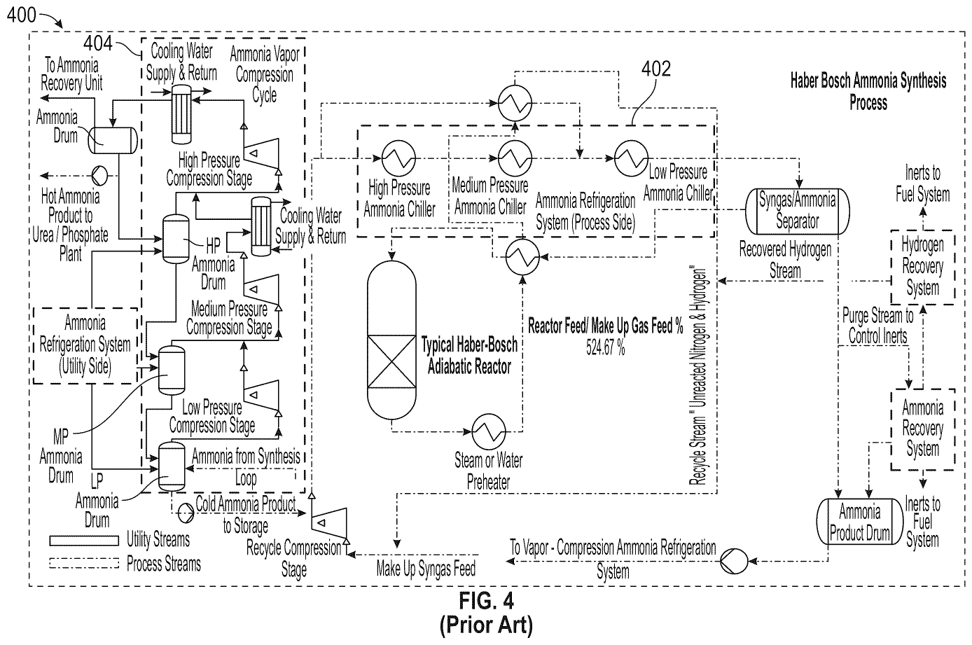

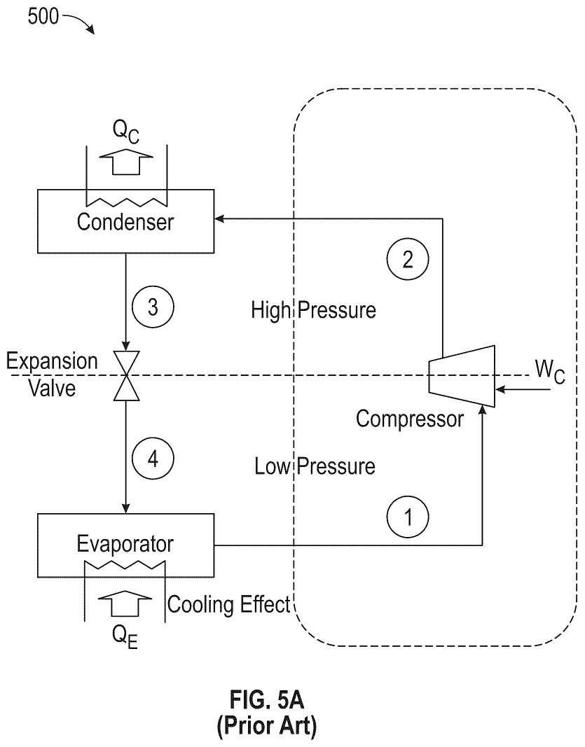

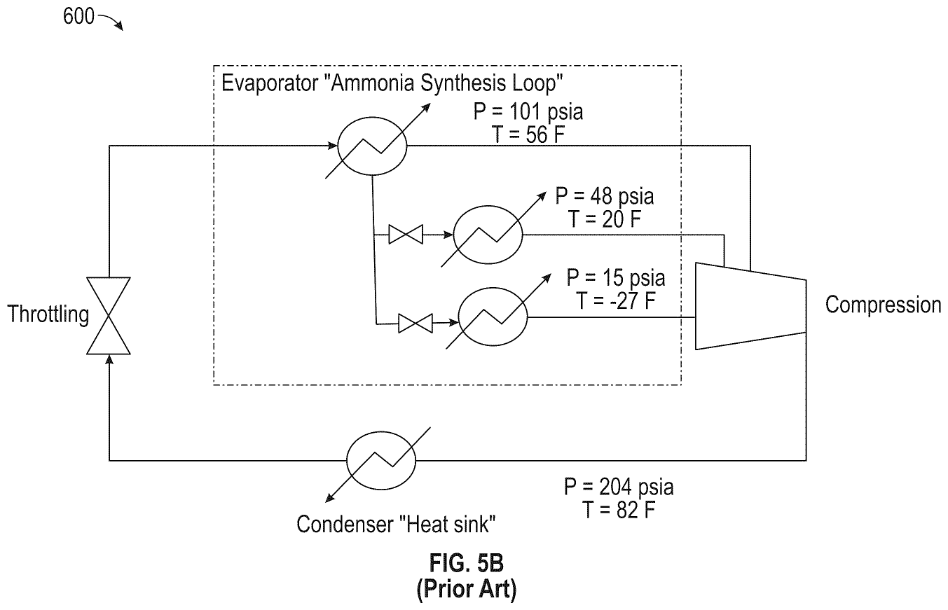

FIG. 4 depicts an example of related art for an ammonia synthesis production unit 400 via the Haber-Bosch process at large scale production. This method utilizes a vapor compression refrigeration cycles 402, 404, where the ammonia fluid is used as a utility for both the synthesis process and the storage of the product. The cycles 402, 404 incorporate chillers, compressors, heat exchangers, condensers, evaporators, expansion valves, or combinations thereof, known to one of ordinary skill in the art. FIG. 5A and FIG. 5B depict examples of related art of such a vapor compression cycle. Vapor compression refrigeration cycles like those depicted in these examples of related art are large consumers of horsepower within current ammonia synthesis processes.

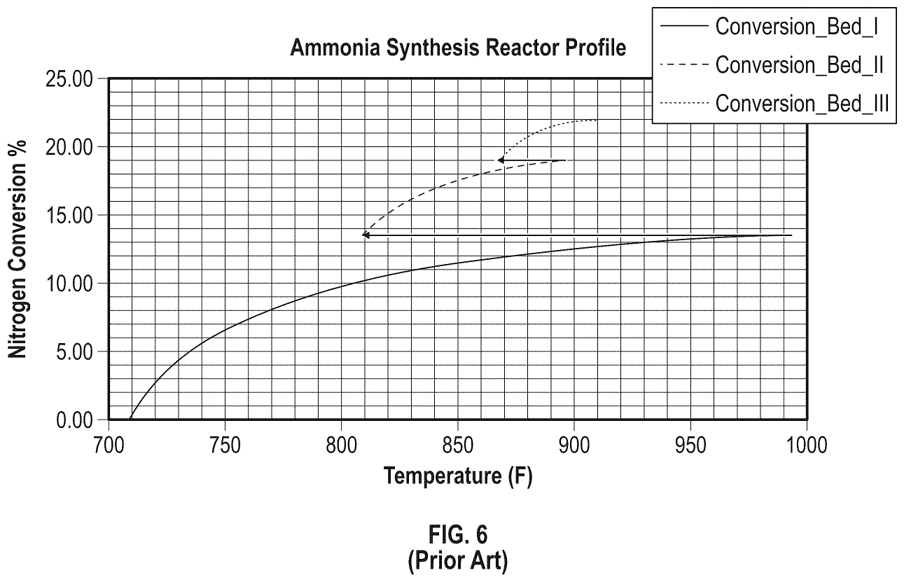

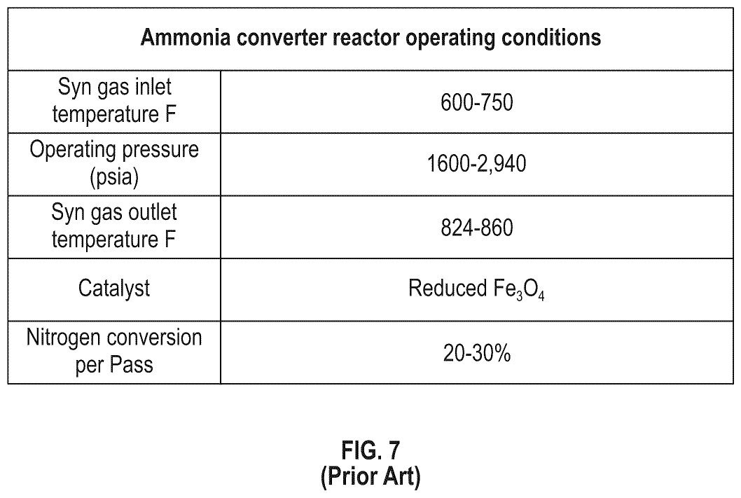

Another issue with current methods, also described supra, is low nitrogen conversion rates. Low nitrogen conversion rates require ammonia synthesis processes to account for large recycle streams, which in turn increase the energy required of the processes overall. FIG. 6 depicts a diagram illustrating the relationship between nitrogen conversion at each of the conversion bed levels in a current ammonia synthesis process and the reaction temperatures within the conversion bed. FIG. 7 discloses current ammonia converter reactor operating conditions in an example of related art, such as those discussed supra.

The disclosed method reduces the high energy demands of ammonia synthesis by removing the vapor compression refrigeration cycle and the recycle compression stage of the synthesis gas compressor. High single pass conversion rates eliminate the need for a vapor compression refrigeration cycle, as well as the need for compression of a recycle stream. Exporting refrigeration to the “front-end” of an ammonia production facility with an ammonia absorption refrigeration cycle reduces overall shaft power requirements and cooling water requirements, further reducing overall energy consumption by the ammonia synthesis process.

In embodiments, a method of ammonia synthesis comprises an ammonia production facility having a front-end unit, comprising an ammonia absorption refrigeration cycle, and a back-end unit, comprising an ammonia synthesis cycle. Unlike the vapor compression refrigeration cycle which is a work-operated cycle that requires work in the form of electrical energy to operate the compressor, as described supra, an absorption refrigeration cycle is a heat-operated cycle that requires mostly heat energy to operate, supplemented with electrical energy as needed, albeit significantly less than the electrical energy needed for a work-operated cycle.

The ammonia synthesis cycle can comprise a multistage non-adiabatic reactor system for converting the syngas to ammonia. The ammonia absorption refrigeration cycle is integrated with the ammonia synthesis non-adiabatic reactor configuration, such that lean ammonia solution is fed as a utility feed to the ammonia non-adiabatic reactor configuration to provide the requisite thermal energy to operate the reactors at favorable reactor conditions for ammonia production. In addition, waste heat recovered from the ammonia synthesis cycle due to the exothermic reactions taking place in the multistage non-adiabatic reactor system can be redistributed to the system, such as to power ammonia chillers integrated into the ammonia synthesis cycle, the ammonia absorption refrigeration cycle, or both.

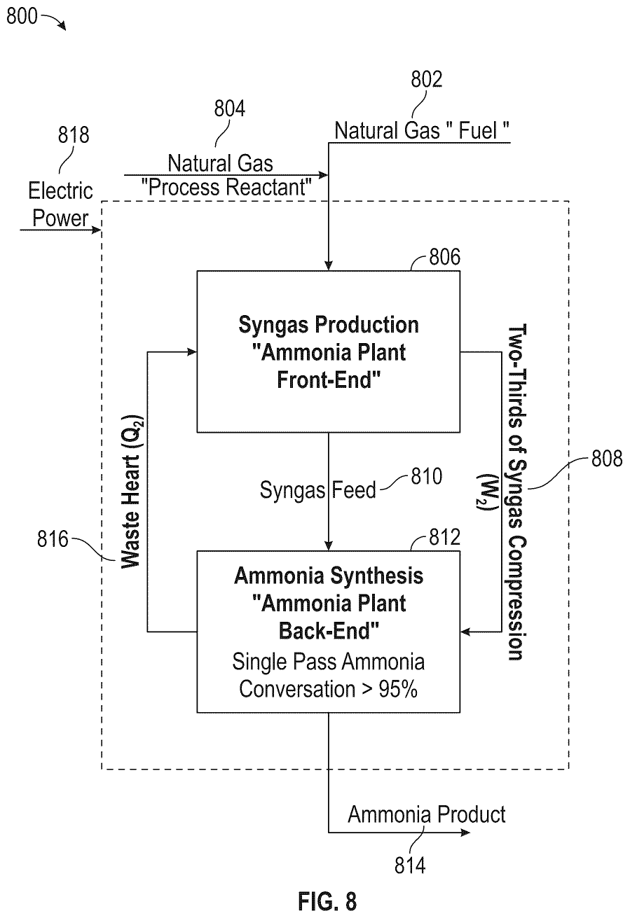

Turning now to FIG. 8, a schematic of a method of ammonia synthesis according to embodiments of the present disclosure that reduces the overall energy consumption is depicted. An ammonia synthesis system 800 can comprise a front-end syngas production unit 806 and a back-end ammonia synthesis unit 812. In the ammonia synthesis system 800, a natural gas feed 802 and a process reactant feed 804 are fed into the front-end syngas production unit 806, similar to the Haber-Bosch process. A syngas feed 810 exits the syngas production unit 806 and enters the ammonia synthesis unit 812, where the syngas 810 undergoes compression work 808 to reduce temperature and pressure. Within the ammonia synthesis unit 812, the syngas feed 810, now compressed, reacts to synthesize ammonia product 814 in a single pass through the ammonia synthesis unit 812, at a nitrogen conversion rate of 85% or greater, more specifically 90% or greater, and even more specifically 95% or greater. A waste heat stream 816 from the ammonia synthesis unit 812 via the exothermic reaction is recycled back into the syngas production unit 806. Electric power 818 is supplied to the ammonia synthesis system 800 as needed.

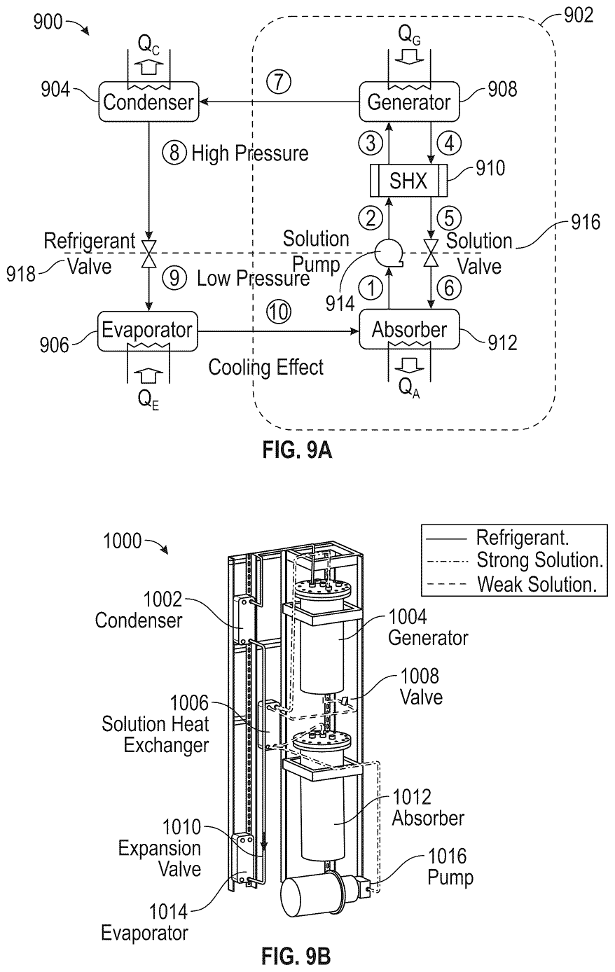

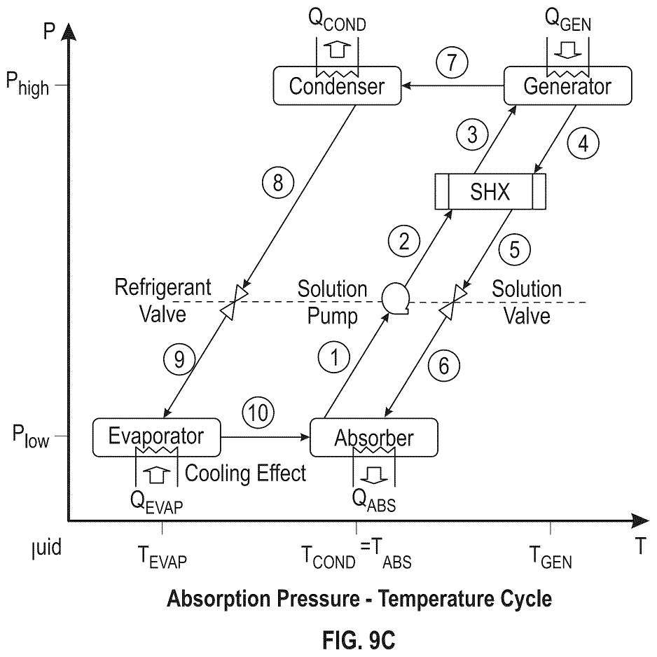

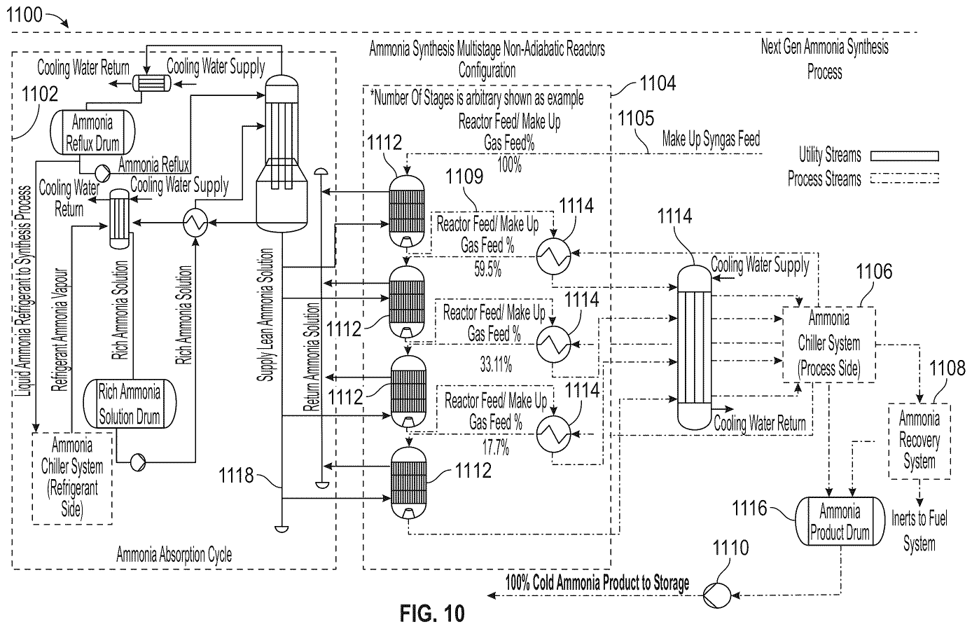

FIG. 9A depicts a schematic of an ammonia absorption refrigeration cycle 900, the absorption cycle comprising a refrigeration unit 902, a condenser 904, and an evaporator 906, the refrigeration unit comprising a generator 908, a solution heat exchanger 910, an absorber 912, a pump 914, a solution valve 916, and a refrigerant expansion valve 918. Such a schematic is exemplary of the efficiency of the ammonia absorption refrigeration cycle compared to the vapor compression refrigeration cycle. Absorption refrigeration cycle 900 generally requires a low boiling point refrigerant, which in this case is ammonia, and a second fluid able to absorb the refrigerant, i.e. an absorbent, which in this case can be water. When the refrigerant evaporates or boils, it takes heat away thereby providing the cooling effect. The refrigerant is then changed back from a gas to a liquid using only thermal or heat methods, unlike vapor compression, and the cycle is repeated. For example, liquid refrigerant (ammonia) is evaporated in the evaporator 906, and the gaseous refrigerant is in turn is fed to the absorber 912 which contains water to absorb the gaseous ammonia. The refrigerant saturated solution is pumped via the pump 914 to the heat exchanger 910 where the solution is heated, and the generator 908 where the solution is heated and the refrigerant, due to its lower boiling point, vaporizes and is separated from the solution as a high-pressure gas. The remaining refrigerant-deficient solution is returned to the absorber 912 via solution pressure reducing valve 916 to reduce the pressure. The gaseous refrigerant enters the condenser 904 where it condenses to a high-pressure liquid, and then is returned to the evaporator 906 via refrigerant expansion valve 918 to lower the pressure. The cycle is then repeated.

The absorption refrigeration cycle 900 can utilize the waste heat from an ammonia synthesis process (not depicted) to drive the thermal process of the absorption refrigeration cycle, instead of requiring additional energy to compress a vapor to achieve refrigeration, or can utilize heat generated from the condenser.

FIG. 9B depicts a configuration of the schematic depicted in FIG. 9A, the refrigeration system 1000 comprising a condenser 1002, a generator 1004, a solution heat exchanger 1006, a valve 1008 coupled the generator 1004 and the solution heat exchanger 1006, an absorber 1012, and expansion valve 1010 coupling an evaporator 1014 to the condenser 1002, and a pump 1016 feeding a strong solution into the absorber 1012.

FIG. 9C depicts a diagram showing the relationship between pressure and temperature in an exemplary ammonia absorption refrigeration cycle, such as those depicted in FIG. 9A and FIG. 9B. The condenser and generator of the exemplary ammonia absorption cycle operate at the highest pressure of the system and at higher temperatures than the evaporator and absorber, which each unit is respectively coupled to.

FIG. 10 depicts an exemplary ammonia synthesis system 1100, comprising an ammonia absorption refrigeration cycle 1102 and an ammonia synthesis cycle 1104. The ammonia absorption refrigeration cycle 1102 and the ammonia synthesis cycle 1104 are integrated such that the absorption refrigeration cycle 1102 supplies the reactors in the ammonia synthesis cycle 1104 with a lean ammonia solution feed 1118 to thermally control the series of reactors 1112 for favorable nitrogen conversion, and optionally ammonia product from cycle 1104 can be used as a refrigerant for the absorption refrigeration cycle 1102, thereby reducing the energy consumption of the system 1100 compared to a traditional Haber-Bosh system.

In embodiments, the ammonia synthesis cycle 1104 can comprise a series of reactors 1112 and heat exchangers 1114. Those skilled in the art will understand that the exact number of stages within the ammonia synthesis cycle depicted is arbitrary and only serves as an example. A synthesis gas feed 1105 is supplied to the ammonia synthesis cycle 1104. The synthesis gas feed may be produced as part of the “front-end” steam reforming process, such as that depicted and described in FIG. 8. The syngas is then reacted in the series of non-adiabatic reactors 1112 of the ammonia synthesis cycle 1104 in a single pass conversion to form a gaseous reaction mixture stream 1109. For each reactor 1112, the resulting stream 1109 containing ammonia and unreacted hydrogen and nitrogen are fed into one or more heat exchangers 1114, where it is cooled and then condensed into a liquid and then directed out of the ammonia synthesis cycle 1104 and into an ammonia chiller system 1106 to separate the ammonia product from the unreacted hydrogen and nitrogen (if present). The ammonia product is then sent to an ammonia recovery system 1108. The ammonia recovery system 1108 can be configured to extract any inert materials within the product ammonia stream to a fuel system (not pictured) of the exemplary ammonia synthesis process 1100. The produced ammonia is then directed to a product drum 1116, where the ammonia can be stored until the ammonia can be directed through a pump 1110 before exiting the exemplary ammonia synthesis process 1100. The unreacted hydrogen and nitrogen stream is then fed to the next reactor 1112 in the series until nearly all of the original syngas feed stream has been converted to ammonia. This single pass can result in a nitrogen conversion rate of approximately 85% or more, 90% or more, or 95% or more, thereby eliminating the need for a recycle stream.

The ammonia absorption cycle 1102 is similar with respect to the cycle described in FIGS. 9A and 9B. Liquid ammonia refrigerant (which can be ammonia product from synthesis cycle 1104) is stored in a chiller system. It is evaporated to a gas, and then absorbed by water in an absorber to form a rich ammonia solution stored in a drum. The rich ammonia solution is then pumped to a heat exchanger and then heated further in a generator in which the ammonia evaporates and separates from the solution. The gaseous ammonia is then sent to a condenser, where it is condensed into an ammonia reflux drum. A portion of the ammonia is pumped back to the generator, and the remaining is sent back to the chiller system. The chilled ammonia can then be reused in cycle 1102, and/or some may be sent to the chiller system 1106 in the synthesis cycle 1106. This allows for cold ammonia product on demand. The lean ammonia solution from the generator is in turn is supplied as a utility line for thermal purposes to control the temperature of the reactors 1107 (heat exchange). The warmed return ammonia solution and other remaining lean ammonia solution from the generator are cooled and returned to the absorber.

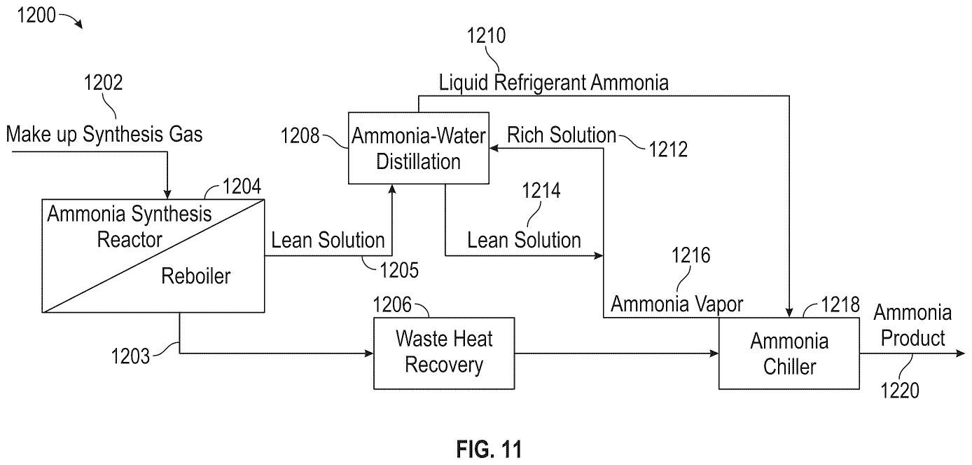

FIG. 11 depicts an exemplary schematic of an example ammonia synthesis process 1200. A synthesis gas feed 1202 is directed into an ammonia synthesis cycle 1204, the ammonia synthesis cycle 1204 comprising at least one ammonia synthesis reactor and at least one reboiler. After the synthesis gas feed 1202 is reacted within the ammonia synthesis cycle 1204, an ammonia product feed 1203 is separated from a first feed of lean solution 1205 and exit the ammonia synthesis cycle 1204. The ammonia product feed 1203 is directed to an ammonia chiller. Recovered waste heat 1206 from the reaction cycle 1204 may be directed back into the ammonia synthesis process as an energy source for certain processes within the ammonia synthesis process, such as for use by an ammonia chiller 1218 to which the ammonia product feed 1203 is fed. The ammonia product feed 1203 is chilled in the ammonia chiller 1218 and an ammonia product stream 1220 exits the ammonia chiller 1218.

The first feed of lean solution 1205 is directed from the ammonia synthesis cycle 1204 to an ammonia-water distillation unit 1208. The ammonia-water distillation unit 1208 produces two feeds: a liquid refrigerant ammonia 1210 and a second feed of lean solution 1214. The liquid refrigerant ammonia 1210 is directed to the ammonia chiller 1218, where it aids in chilling the ammonia product line 1203. In the ammonia chiller 1218, the liquid refrigerant ammonia 1218 is evaporated, producing ammonia vapor 1216. The ammonia vapor 1216 exits the ammonia chiller 1218 and is directed back to the ammonia-water distillation unit, where the ammonia vapor 1216 is joined with the second feed of lean solution 1214 to form a rich solution 1212. The rich solution 1212 then enters the ammonia-water distillation unit 1208 along with lean solution 12105, and the cycle is repeated.

The embodiments of the present disclosure directed to a non-adiabatic/semi-isothermal multistage reactor design produces an isothermal, non-adiabatic temperature profile, produces a nitrogen conversion of approximately 85-99.9%, and more specifically about 90-99.9% per single pass compared to less than 30% nitrogen conversion per single pass of the Haber-Bosch process. This high conversion rate requires no recycle stream resulting in complete elimination of 20-30% of the syngas compression horsepower requirements otherwise required by the Haber-Bosch process. The high recycle stream of the Haber-Bosch process also results in high concentration of inters such as argon and methane that leads to the requirement of oversizing the reactor. Minimum inert and temperature profile control of the current embodiments instead leads to smaller reactor size and minimized the synthesis gas pressure requirements leading to further reduction in synthesis gas compression.

In the Haber-Bosch process, the ammonia compression horsepower demand is maximized when 100% of ammonia is sent as cold product to storage, whereas the current embodiments allow 100% of ammonia be sent as cold product to storage on demand, and complete elimination of the horsepower requirements of the ammonia refrigeration compressor.

Finally, current ammonia plants are hitting mechanical limitations in size of the refrigeration compressors in addition to the recycle stage of the syngas compressor due to exponential jump flow rate of the syngas loop. The current embodiments eliminate the mechanical bottlenecks of these mega size ammonia plants, and the larger the plant, the more significant the energy savings between processes of the current embodiments and the Haber-Bosch process.

According to embodiments, due to the exotherm of the reaction and the reactor design, the amount of heat produced by the reaction is not only sufficient to fulfill the refrigeration requirement by the synthesis system but also results in excess refrigeration duty to be exported elsewhere in the process. In the Haber-Bosch process, most of the reaction heat is instead utilized internally within the reactor, rendering the adiabatic nature of the design.

Various embodiments of systems, devices, and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the invention.

Persons of ordinary skill in the art will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features. The invention can comprise a combination of different individual features selected from different individual embodiments, as understood be persons of ordinary skill in the art. Further, elements described with respect to ne embodiment can be implemented in other embodiments even when not described in such embodiments unless otherwise noted. These combinations are proposed herein unless it is stated that a specific combination is not intended.

1. A system for producing ammonia, comprising:
an ammonia absorption refrigeration cycle, wherein a refrigerant comprises ammonia; and
an ammonia synthesis cycle comprising a multistage, non-adiabatic reactor system, wherein the multistage, non-adiabatic reactor system is configured to receive a synthesis gas containing hydrogen and nitrogen to be reacted in the presence of a catalyst to produce a reaction mixture containing an ammonia in a single pass,
wherein waste heat from the ammonia synthesis cycle is supplied to the ammonia absorption refrigeration cycle,
wherein lean ammonia solution from the ammonia absorption refrigeration cycle is supplied to the reactor system as a heat exchange fluid.

2. The system of claim 1, wherein the ammonia absorption refrigeration cycle is configured to supply lean ammonia solution to the multi-stage, non-adiabatic reactor system to control a thermal condition of the reactor system.

3. The system of claim 2, wherein the lean solution from the ammonia absorption refrigeration cycle is supplied to and returned each reactor of the multistage, non-adiabatic reactor system.

4. The system of claim 1, wherein the multistage, non-adiabatic reactor system comprises at least two ammonia reactors and at least one heat exchanger.

5. The system of claim 1, wherein the reaction mixture exits the ammonia synthesis cycle and is directed to an ammonia chiller system.

6. The system of claim 1, wherein a nitrogen conversion of the ammonia synthesis cycle is at least 85%.

7. The system of claim 6, wherein the nitrogen conversion of the ammonia synthesis cycle is at least 90%.

8. The system of claim 7, wherein the nitrogen conversion of the ammonia synthesis cycle is at least 95%.

9. The system of claim 1, wherein the ammonia synthesis cycle is completely free of a recycled syngas stream.

10. The system of claim 1, wherein the ammonia absorption refrigeration cycle comprises:
an evaporator configured to convert liquid ammonia to gaseous ammonia;
an absorber configured to combine the gaseous ammonia with water to form an ammonia-rich solution;
a generator configured to heat the ammonia-rich solution to convert the ammonia contained therein to gaseous ammonia while the remaining solution remains liquid to be returned to the absorber; and
a condenser for condensing the gaseous ammonia from the generator into liquid ammonia to be returned to the evaporator.

11. The system of claim 10, wherein the ammonia absorption refrigeration cycle further comprises:
a pump configured to pump the ammonia-rich solution to the generator;
a pressure reducing valve positioned between the generator and the absorber and configured to reduce a pressure of the remaining solution returning from the generator to the absorber; and
an expansion valve positioned between the condenser and the evaporator and configured to reduce a pressure of the liquid ammonia returning from the condenser to the evaporator.

12. A method of producing ammonia, the method comprising:
introducing a synthesis gas comprising hydrogen and nitrogen to an ammonia synthesis cycle comprising a multistage, non-adiabatic reactor system to produce a reaction mixture containing ammonia product and unreacted synthesis gas;
separating the ammonia product from the unreacted synthesis gas;
providing the ammonia product to a chiller system; and
providing a lean ammonia solution from an ammonia absorption refrigeration cycle to the reactor system as a heat exchange fluid.

13. The method of claim 12, further comprising:
providing waste heat from the ammonia synthesis cycle is supplied to the ammonia absorption refrigeration cycle.

14. The method of claim 12, wherein the ammonia product is produced from the synthesis gas in a single pass through the multistage, non-adiabatic reactor system.

15. The method of claim 12, wherein the chiller system utilizes ammonia refrigerant from the ammonia absorption cycle.

16. The method of claim 12, wherein a nitrogen conversion of the ammonia synthesis cycle is at least 85%.

17. The method of claim 16, wherein the nitrogen conversion of the ammonia synthesis cycle is at least 90%.

18. The method of claim 17, wherein the nitrogen conversion of the ammonia synthesis cycle is at least 95%.

19. The method of claim 12, wherein the ammonia synthesis cycle is completely free of a recycled syngas stream.

20. The method of claim 13, wherein the ammonia absorption refrigeration cycle comprises:
providing liquid ammonia to an evaporator;
evaporating the liquid ammonia to form a gaseous ammonia stream and a cooling effect;
absorbing the gaseous ammonia stream into water in an absorber to form an ammonia rich solution;
heating the ammonia rich solution in a generator to vaporize the ammonia in the ammonia rich solution to form a high pressure ammonia gas and the lean ammonia solution;
providing the high pressure ammonia gas to a condenser to condense the high pressure ammonia gas into a high pressure ammonia liquid;
converting the high pressure ammonia liquid to a low pressure ammonia liquid; and
returning the low pressure ammonia liquid to the evaporator.

21. The method of claim 20, further comprising:
after the ammonia has been vaporized from the ammonia rich solution, returning the lean ammonia solution to the absorber and/or to the reactor system.

22. The method of claim 20, wherein the generator is powered by the waste heat.
